(19) United States
(12) Patent Application Publication
(10) Pub. No.: US 2022/0296934 A1
(43) Pub. Date: Sep. 22, 2022

(54) Combination Respirator-Facemask Device

(71) Applicant: Phillip Reyes, Tempe, AZ (US)

(72) Inventor: Phillip Reyes, Tempe, AZ (US)

(21) Appl. No.: 17/698,126

(22) Filed: Mar. 18, 2022

Related U.S. Application Data
(60) Provisional application No. 63/162,983, filed on Mar. 18, 2021.

(51) Int. Cl. A62B 7/10; A62B 18/02

(52) U.S. Cl. CPC A62B 7/10; A62B 18/025

(57) ABSTRACT

A breathing device related to the field of personal protective equipment and wearable technology that can be cleaned and sterilized so that it can be used repeatedly is disclosed herein. The device is configured to surround the mouth and nose of the user, and in some embodiments, it surrounds the eyes. The perimeter of the device can be comprised of a stretchable material that conforms to the contours of the user's face so that it provides an adequate seal, and in doing so, ensures that all or most of the air flowing through the device occurs through its air filtering regions. The filtering region is configured so that filtering material can be mounted to the device and replaced when needed. This filtering region is also configured so that a negative pressure seal test can be performed. Various embodiments of the device exist that enhance its capabilities from its most basic form. For example, in some embodiments, wearable technology is mounted to the device, is connected to the device, or is embedded within the device. This technology can include, but it not limited to sensors, microprocessors, cables, wires, actuators, soft robotic or soft machine materials, energy supply systems, and smart materials.

### TECHNICAL FIELD

The subject of the invention relates to the field of personal protective equipment and wearable technology.

### BACKGROUND OF THE INVENTION

COVID-19, a respiratory virus, is thought to spread mainly between people who are in close contact with one another, or who are in an enclosed environment for an extended period of time, through the transmission of respiratory droplets and aerosols that are emitted from a person when the infected person coughs, sneezes, or talks. See, e.g., <https://www.cdc.gov/coronavirus/2019-ncov/prevent-getting-sick/how-covid-spreads.html>

During the COVID-19 pandemic there was a tremendous increase in the demand for personal protective equipment (PPE). Due to the mechanism of the transmission of the virus, face masks and respirators became a vital element in the PPE regimen.

As the pandemic spread, PPE manufacturers struggled to meet the unprecedented increase in demand. The ensuing shortages left health care providers in the precarious position of having to provide care while often needing to use PPE beyond their recommended use, thus, putting themselves at greater risk of contracting the virus. Images of healthcare providers constructing their own PPE out of garbage bags and other available materials, for example, became prevalent. Some hospitals even started accepting donations of homemade respiratory protection from the public. In an effort to slow the spread of the virus, governments began recommending that all citizens wear face masks when going into public to mitigate transmission. Images of the general public constructing their own homemade masks made out of various materials, such as fabrics sewn together, also became common just as it did with healthcare providers.

Due to the shortage of PPE, in particular the shortage of respiratory PPE during the COVID-19 pandemic, people from all walks of life proactively began finding ways in which they could create their own masks using any type of material that could meet their design requirements. Even though various classifications of respiratory PPE exist, they were commonly all referred to as masks.

As previously mentioned, fabric-based masks were very common and oftentimes were manufactured at a designer's home using a sewing machine which allowed for the designer to showcase their sewing skills and express their sense of fashion. Other do-it-yourself makers used 3D printers to print a respirator-like design in the form of a hard-protective-shell that could then be strapped to the user's head and have a filter attached. Just as the designs and materials for these masks varied greatly, so did the materials used for the filtering elements of the mask. Various fabrics, pieces of cut up surgical masks, HVAC filters, and even vacuum and coffee filters were reported to have been used as the filtering materials for these masks.

When determining the efficacy of a mask the proper handling as well as the exposure time of the user in a certain environment are just two of many important factors to consider. However, these two factors, in large part, are dependent on the user's awareness and ability to mitigate exposure and contamination in various situations. Two key factors in the physical design of the mask are its ability to filter and its ability to provide an adequate seal. The N95 respirator meets both criteria of high filtering capability and proper sealing function. The N95 has been studied extensively and is the gold standard for masks. Numerous studies have also been conducted on surgical face masks, and while they have been shown to meet a certain degree of filtering capability, they do not meet the same level of sealing capability around their perimeter as the N95 does around its perimeter.

### SUMMARY OF THE INVENTION

The invention disclosed here contemplates elements that allow the user to add and remove filtering material when needed, while also providing the ability to seal the area around the perimeter of the system and the user's face. The system can be sterilized and reused repeatedly and can be configured so that a negative pressure seal test can easily be conducted. Other embodiments of the system can enhance the capabilities of the system.

The respirator, and components of the respirator, can comprise any of the following materials, a combination of the following materials, or a material not listed here: silicone, latex, acrylonitrile butadiene styrene, thermoplastic polyurethane, polyurethane terephthalate, epoxies, polyvinyl chloride, foam, wax, gels, granular materials, soft biological materials, piezoelectric materials, shape-memory polymers, magnetostrictive materials, magnetic shape-memory alloys, smart inorganic polymers, temperature-responsive polymers, ferrofluid materials, pneumatic response materials, soft robotics materials.

The invention disclosed here provides a device that reduces the exposure of the user's mucosae and conjunctiva from the ambient environment by encapsulating the areas around the nose and mouth, and in some embodiments the user's eyes, with a stretchable material that conforms to the contours of the user's face. The device can be cleaned and or sterilized for repeated use. Filtering material, e.g., commercial or custom or a combination thereof, can be used with the device to filter the air that the user inhales and exhales. The space between the perimeter of the device, which resides against the contours of the user's face, can be adjusted for comfort while maintaining a seal so that any air that passes through the device is completely or mostly passing through the filtering system and not between the user's face and the perimeter of the device. In some embodiments, the adjustment can be made through the use of straps that pull the device tightly against the user's face. Additionally, areas can extend from the perimeter or the inside surface of the device to fill voids where there would otherwise exist gaps between the device and the user's face if the device were less pliable and if those extended areas did not exist. These areas that extend to fill voids can be comprised of the same stretchable material or another type of material that provides comfort and can provide an adequate seal between the user's face and the device. The device can be configured so that a user can perform a negative pressure seal test. Other embodiments of the device enhance various capabilities.

### BRIEF DESCRIPTION OF DRAWINGS

FIG. 1 is a schematic illustration of two example embodiments.

FIG. 2 is a schematic illustration of two example embodiments with extended regions of coverage.

FIG. 3 is a schematic illustration of an example embodiment with various components and features of a filter chamber system.

FIGS. 4,5, and 6 provide schematic illustrations of example embodiments of the securing member and the filter chamber.

FIG. 7 is a schematic illustration of feature details of a filter chamber and securing member.

FIG. 8 is a schematic illustration of an embodiment of a two-piece securing member.

FIG. 9 is a schematic illustration of an encapsulated filter.

FIG. 10 is a schematic illustration of a space in the respirator for adding a filter or other members.

FIG. 11 is schematic illustration of an embodiment with elements used to fix the securing member to the respirator.

FIG. 12 is a schematic illustration of openings and divisions in the filter chamber and the securing member.

FIG. 13 is a schematic illustration of superstructures on a respirator.

FIG. 14 is a schematic illustration of a negative pressure testing element.

FIG. 15 is a schematic illustration of pliable, contouring material around the perimeter of the respirator cup.

FIG. 16 is a schematic illustration of a pliable, contouring superstructure on a inside perimeter of the respirator.

FIG. 17 is a detailed schematic illustration of a pliable contouring superstructure.

FIG. 18 is a schematic illustration of a chin rest.

FIG. 19 is a schematic illustration of proximal and distal regions of a respirator.

FIGS. 20 and 21 are schematic illustrations of embodiments with granular jamming technology.

FIG. 22 is a schematic illustration of an embodiment with a region that has a dampening feature and points of attachment for the harnessing straps.

FIG. 23 is a schematic illustration of an embodiment with additional material provided for dampening and sealing.

FIG. 24 is a schematic illustration of the filter chamber residing in a position that frees space in the distal region of the embodiment.

FIG. 25 is a schematic illustration of embodiments with variations in the number of straps used.

FIG. 26 is a schematic illustration of an embodiment where the straps are a continuous piece of the respirator system.

FIG. 27 is a schematic illustration of a harnessing system with loops.

FIG. 28 is a schematic illustration of a clasping element used to reduce the length of the harnessing system.

FIG. 29 is a schematic illustration of a two-piece harnessing system with a clasp used for joining the two pieces.

FIG. 30 is a schematic illustration of a two-piece harnessing system with the clasp configured into one of the ends of the harnessing system.

FIG. 31 is a schematic illustration of a filtering system connected to a harnessing system configured with lumens.

FIG. 32 is a schematic illustration with the filtering system in-line with the harnessing system configured with lumens.

FIGS. 33 and 34 provide schematic illustrations of embodiments with clear regions.

FIGS. 35, 36, 37 and 38 provide schematic illustrations of embodiments with eye protection.

### DETAILED DESCRIPTION OF THE INVENTION

A respirator, such as the one described herein, is one that can be used and sterilized repeatedly. It is comprised of a compliant material so that it conforms to the various face shapes and sizes of users. The compliant material also provides an adequate seal so that all or most of the air inhaled and exhaled passes through the filtering regions of the device instead of around its sides. This material also serves as an interface that is comfortable, while at the same time maintaining sufficient rigidity so that a cup-like structure is maintained, thus, allowing for there to be a comfortable amount of space between the respirator and the user's mouth and nose.

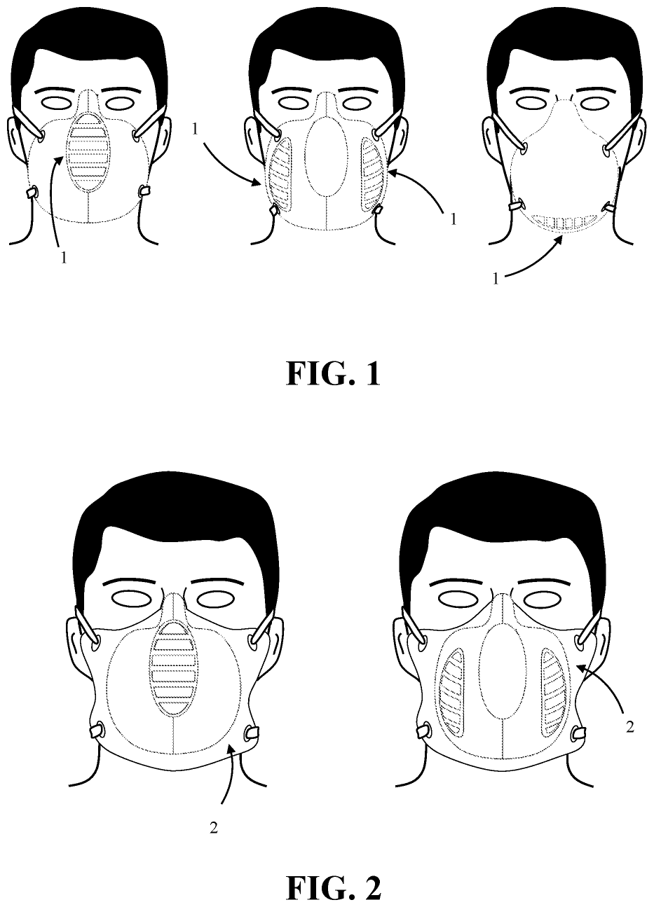

Embodiments of the respirator, as the ones shown in FIG. 1, can have one or more than one filter chamber 1 where a filtering material can be inserted and held in place with a securing member and then removed when necessary. A filter chamber can be located at any of various locations on a cup portion, including as examples in front of the user's nose, to either side of the nose, or under the mouth or under the chin, as illustrated in FIG. 1. Several embodiments exist for the securing member mechanism. For example, the filter can be held in place with a member that is fixed to and rotates on a hinge and can close, or the member can be a separate article that is not attached to the respirator and that slides into place on a groove or track to secure the filter, or the member can be screwed into place, or the member can be pressed into place to secure the filter. In some of these embodiments, the member holding the filter remains fixed to the chamber once in position due to the pressure imparted onto its perimeter and onto the perimeter of the chamber. In other embodiments of the respirator the chamber exists in the anterior region below the user's mouth, on the sides of the user's head, on the back of the user's head, and as a standalone unit separate from the respirator but still connected to it with a tube so that air can pass between the respirator and the chamber.

Some embodiments of the respirator provide extended regions 2 of coverage, as depicted in FIG. 2. These extended regions assist with comfort and fit, as well as improving the sealing capability of the respirator. As with the embodiments described in FIG. 1, the embodiments represented by FIG. 2 can also comprise one or more than one filter chamber.

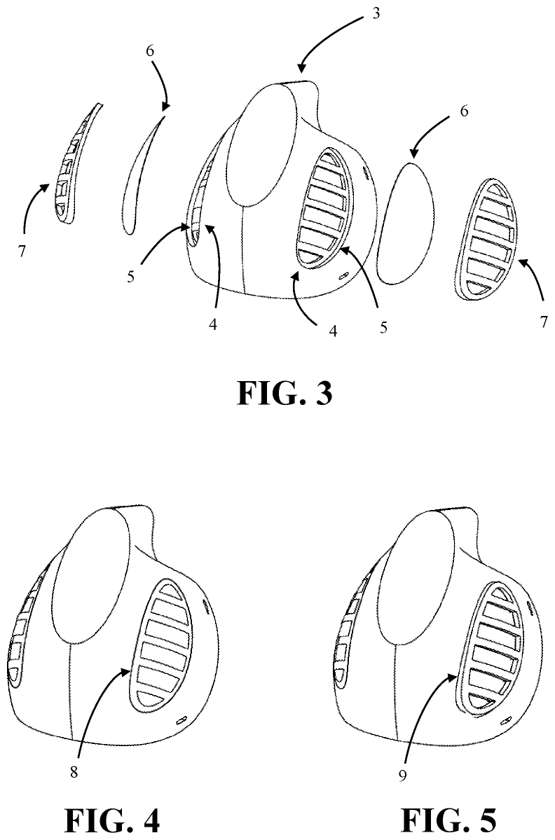

FIG. 3 depicts an embodiment of a respirator 3 with two chambers 4. A chamber, in this embodiment, resides below the surface of the respirator 5 to allow space for a filter 6 to be inserted and a securing member to be placed over the filter 7 and pressed snugly into position inside the depressed area of the chamber. The securing member resides flush 8 with the exterior surface of the respirator when it has been secured, as shown in FIG. 4, or in a similar embodiment, it can reside above the exterior surface 9 of the respirator when secured, as shown in FIG. 5. In another embodiment, the chamber can reside above the interior surface 10 of the respirator as shown in FIG. 6.

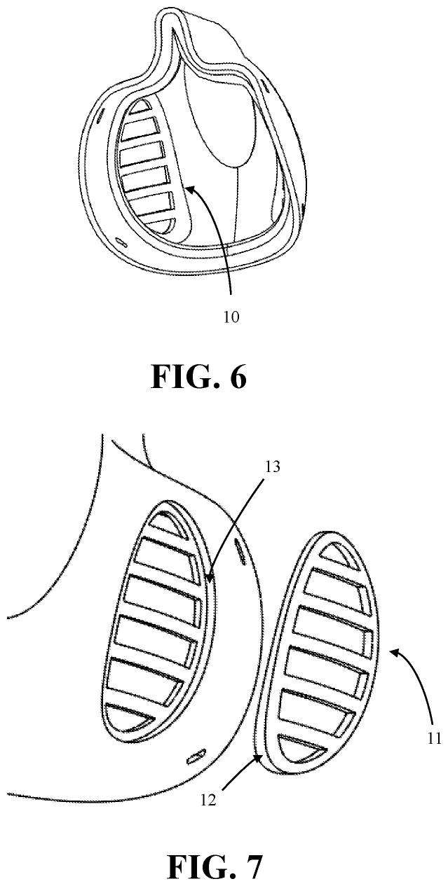

The securing member 11, as depicted in FIG. 7, can comprise a rigid material that can be snapped into the chamber, or it can comprise a flexible material so that the securing member is press-fit into the chamber. In another embodiment of the securing member, the rigid material is encapsulated by a softer material, such as a polymer. This softer material acts as a gasket and adds an improved sealing capability around the perimeter 12 of the securing member as well as providing for a tighter fit with the chamber. The perimeter of the chamber 13 can be a rigid material or it can comprise a softer material that adds to the sealing capability of the region. As with the embodiment of the securing member just described, this softer material also enhances the fit of the chamber with the securing member.

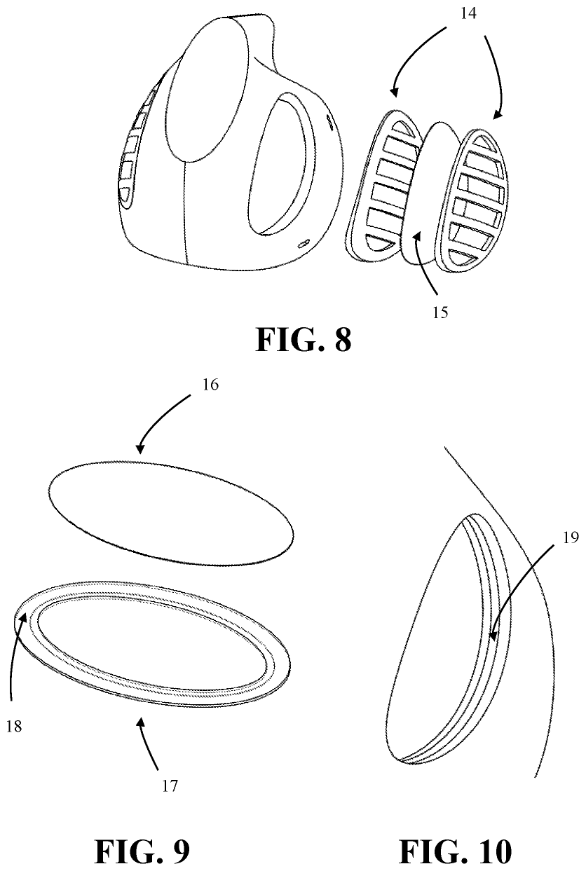

In another embodiment of the chamber system, the securing member comprises two separate pieces 14. The two pieces are joined to enclose the filter 15 between the two pieces, as depicted in FIG. 8. Once joined, the resulting component can be attached to the respirator.

In another embodiment of a securing member, the filter is manufactured along with the securing member as one piece. In this embodiment, the combination securing member-filter can be added to or removed from the respirator as one piece and either discarded when it has reached its maximum use, or it can be removed and then reused after it has been sterilized. FIG. 9 depicts a filter 16 and below it a filter encapsulated with a polymer 17. In this embodiment the filter is encapsulated along its perimeter with the polymer 18. The polymer serves as both a securing element and a sealing element when placed within the chamber, while still allowing for air to flow through the unencapsulated region of the filter. Similarly, in another embodiment, the filter is embedded in the respirator during the manufacturing process of the respirator. In this embodiment, the filter is not able to be removed from the respirator and has an area exposed for air to pass in and out of the system. In another embodiment, the encapsulated filter, once placed inside the chamber, is secured with a securing member.

The filter can be encapsulated with a material that is pliable or rigid, or in some embodiments, with both a rigid and a pliable material. For example, the filter can be encapsulated with a rigid material so that it holds a rigid form and has stability when it is inserted into the chamber. A pliable material can then be used to encapsulate the rigid material which is already encapsulating the filter. The pliable material in this example would provide sealing capability. A securing member can be constructed in the same way using the combination of materials and processes just described for the filtering material.

FIG. 10 depicts an embodiment of a filter chamber where there is a gap 19 between the outer surface and the inner surface around the perimeter of the opening of the chamber area. The perimeter of this gap is larger than the perimeter of the opening allowing for a filter and or a securing element for the filter to be placed. The width of the gap provides just enough space for the filter to be inserted, but not too much space so that there can still be a compressive pressure applied against the filter from the walls of the gap. Various embodiments of this chamber area feature exist. For example, the space can be configured to accommodate a filter alone as just described, a filter that is encapsulated as the one described in FIG. 9, a filter encapsulated with a polymer and a rigid material, or any of the previously mentioned embodiments with the addition of a securing member.

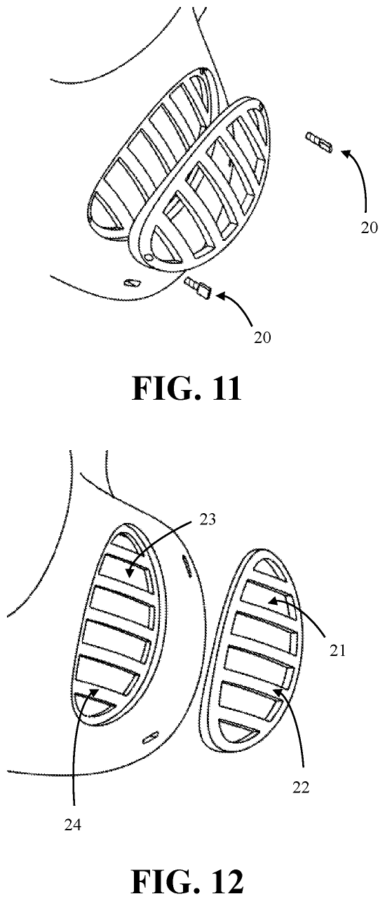

In another embodiment, the securing member as depicted in FIG. 11, is secured in place with a screw or more than one screw 20, or with a different type of securing element.

In addition to the filter, embodiments with structures within or on the respirator also aid in the filtering of air. These structures can also reside on the securing member as shown in FIG. 12. A series of openings 21 that allow air to enter and exit the system, while being filtered by the filter, exist on the securing member of this embodiment. A series of divisions between the openings 22 provide a shield against the flow of air. These divisions serve as a means to block some air flow and potentially some particulates while also serving as a means to secure the filter against the surface of the chamber. The filter chamber in this embodiment is configured with the same series of openings 23 and divisions 24 as the securing member. In other embodiments, the openings and divisions can exist in a variety of geometric configurations, such as hexagons or circles, and are not limited to the configuration depicted in FIG. 12.

Other elements can be used to enhance the fit and seal of the chamber system and the securing member. For example, a riser element can be placed between the filter and the securing member to reduce any space that might exist between the filter and securing member, and thus translate pressure from the securing member onto the filter. The riser can be configured to take the shape of the perimeter of the chamber and have an opening that still exposes the filter so that air can pass through the filter. The riser element can also comprise a series of openings and divisions.

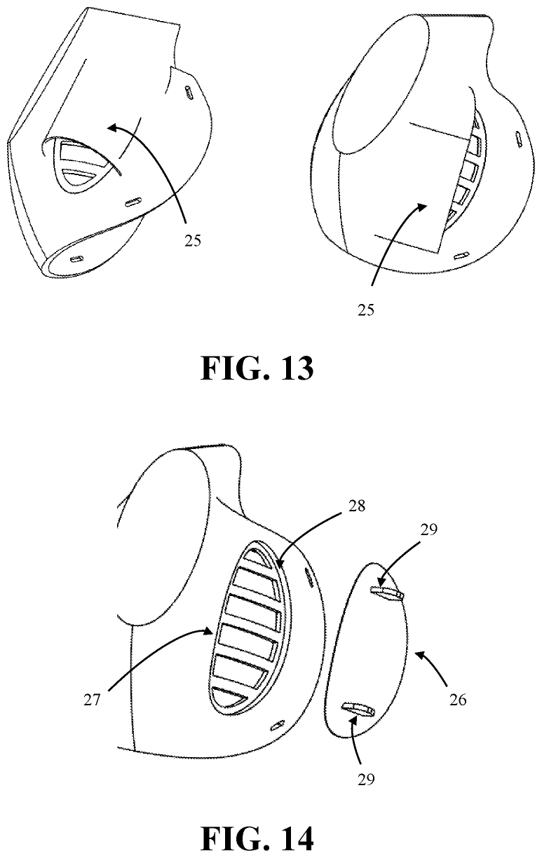

Other means to prevent the direct impact of air and particulates against the filter exist as superstructures around the chamber areas, two embodiments of which are shown in FIG. 13. A superstructure 25 can comprise the same material as the respirator or a different material and be continuous with the respirator. It can also exist as a stand-alone piece and be used as an accessory attachment.

Wearable technology can be employed in the detection of various ambient conditions such as humidity, temperature, and the concentration of particulates in the ambient environment. This sensing technology can exist on the surface of the respirator, or on the elements of the chamber structure or securing member. For example, the chamber or securing element can contain sensor technology that indicates when the user has been exposed to a certain level of particulate concentration, or it can detect when the filter is nearing a level of saturation that requires it to be replaced. Sensor technology can also be employed to detect oxygen and carbon dioxide levels in the interior of the respirator. Bacteria levels can also be detected with sensors in or on the respirator. The sensing technology can comprise electronic sensors and or other components. The technology can notify the user when ambient or local conditions have been reached through color changes, haptic, audio, or visual feedback. Technology can also be employed that can sterilize the system or neutralize pathogens or bacteria. This technology can be embedded within the system or exist on the surface. The filtering capability of the device can be enhanced by electrostatically charging the filtering region or its components. For example, the securing element or other elements of the filter chamber, such as the perimeter of the chamber or the divisions of the chamber or the securing element, can be electrostatically charged. The electrostatically charged areas can further be enhanced through the implementation of a multi-layer filtering system. By adding layers of filtering materials to the system, the filtering capacity increases due to the increase in filter surface area. In this example, the electrostatically charged areas are similar in structure and function to organ systems such as a kidney system or the gills of a fish.

A negative pressure test is performed when properly fitting an N95 respirator. This negative pressure test ensures that the respirator is providing an adequate seal. Embodiments of the invention disclosed here, have the feature that allows the user to perform their own negative pressure test using their hands to block the flow of air, or by using an accessory testing component as depicted in FIG. 14. The component can be attached to the respirator to perform the test and removed after the test has been completed. This component 26 can be inserted or placed over the filter chamber 27 to block the flow of air and perform the negative pressure test. In this embodiment, an indentation in the filter chamber 28 residing distal to the seated position of the securing element exists so that the component can snugly fit and prevent the flow of air. Once in place the user can attempt to inhale and exhale to test whether the respirator is providing a seal. The straps holding the respirator in place can be adjusted accordingly based on this test. For example, while performing the negative pressure test using the component, any air that is detected to be leaking into the system would be due to the seal around the perimeter of the respirator not being sufficiently snug against the user's face. The user would simply need to tighten the straps or reposition the respirator accordingly until air is not leaking. In another embodiment, an indentation around the perimeter of the outside of the chamber can exist where the testing element can be pressed into and secured in order to conduct the test. In a similar embodiment, the testing element can be attached in the same way to a securing member that also has an indentation.

The testing element can comprise a rigid or pliable material or a combination of such materials. It can have members that extend from its surface so that the user can grasp it with his or her fingers to make it easier to handle 29. The member can also be used to trace, onto a custom filter material, the outline of the area and dimension of filter needed for the chamber. Excess filter material can be trimmed away from the filter using the outline that was traced as a guide. Once excess filter material is trimmed, the custom filter can be inserted for use.

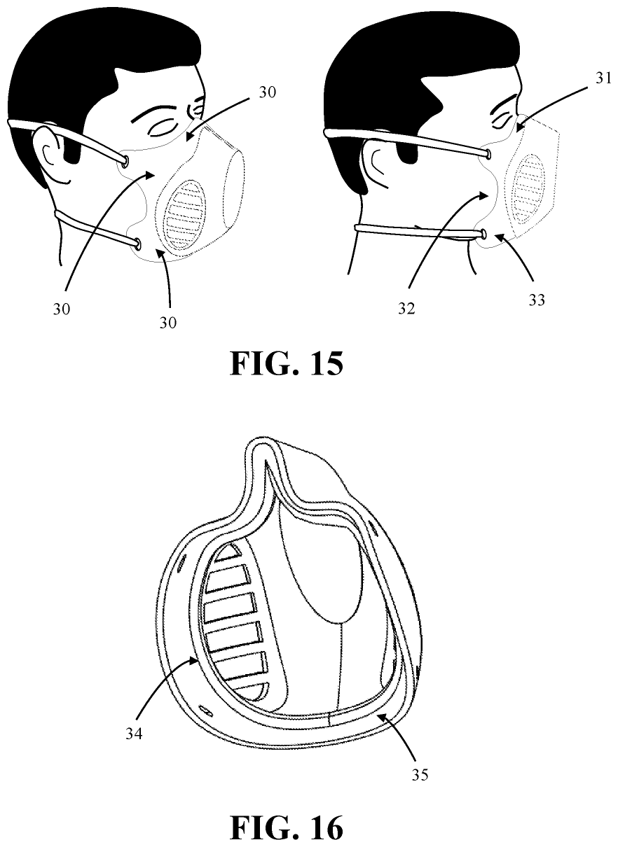

The respirator can comprise, or have sections that comprise, a stretchable material that conforms to the contours of the user's face as depicted in FIG. 15. Contouring around the perimeter of the user's mouth and nose can be important to provide an adequate seal to prevent air from seeping in or out of the system. These areas can be difficult to design an adequate seal due to the variability in facial shapes. The sides of the respirator can also be difficult to design for proper sealing due to the variability in facial movements related to the mouth. For example, while talking or laughing, the sides of a respirator can become vulnerable to air seepage due to the movement and changing geometry that can push the mask away from the user's face while exposing other areas of the face near the mouth. One way in which the invention disclosed here accounts for various geometries is by extending the cup area of the respirator to form a projecting edge, or lip, to cover more surface area of the face with a stretchable material which adds to the sealing capability of the respirator 30. This additional feature extends around the perimeter of the respirator with special attention paid to the difficult areas previously mentioned: the nose 31, mouth 32, and chin 33.

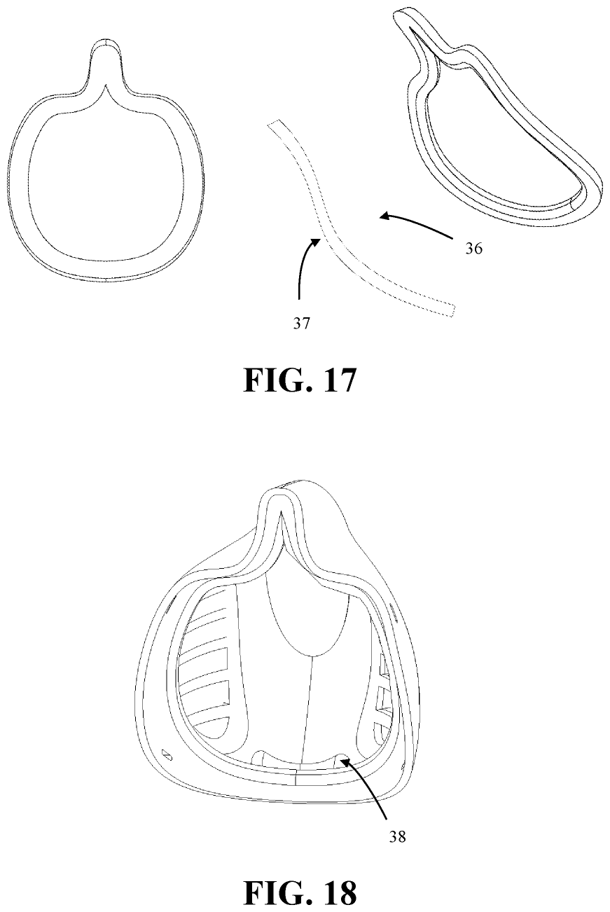

A structure that extends 34 from the perimeter on the inside surface of the respirator 35 can provide additional sealing capability as depicted in FIG. 16. The extending structure can also conform to the contours and geometry of the user's face. It can comprise the same material as the material referred to in FIG. 15, or it can comprise a different yet still soft and pliable material. FIG. 17 shows three views of a structure used for sealing independent of the respirator. It can have a saddle-like shape 36 that follows the curvature of the face. When the respirator stretches and presses against the user's face, the underside of the saddle shaped structure also presses against and contours to the user's face 37. In one embodiment, the structure is a removable element. In other embodiments it is a not a separate piece and it is continuous with the rest of the respirator comprised of the same stretchable and pliable material as the respirator or a similar material. In another embodiment, the structure that contours to the user's face, exists as hollow material, impermeable to air, that can have air pumped inside it so that its volume increases to adequately provide a seal around the user's face. This system has a pump embedded within the material of the respirator that can be manually operated by pressing against a valve with the user's finger. The pumping system of this structure is similar to the concept of the Reebok Pump shoes from the 1980s and 1990's. Another embodiment of this pumping system has the pump residing as an independent piece that is connected to the respirator through an air hose. In another embodiment of the structure a bead of wax, or any other low heat temperature deformable material, is embedded within the structure and extends along the perimeter of the respirator. In this embodiment, the user can apply a small amount of heat to the perimeter of the respirator to deform the encapsulated wax and then apply the respirator to his or her face and allow the wax to cool. This process, after the wax has cooled, allows the wax and structure to contour to the user's face. This feature makes the design customizable to the face contours of any user. The structures previously mentioned can reside on the perimeter of the respirator area that is in contact with the user's face or on the interior of the perimeter 34. Embodiments of the structure are not limited to the example shapes and materials described here.

In other embodiments, near or on the previously mentioned structure are pressure contact sensors that detect whether the respirator is in contact with the user's face and thus providing an adequate seal. These sensors can reside across the entire perimeter of the respirator portion that is in contact with the user's face, or they can be strategically placed. If the sensors detect that there is not an adequate seal, they can alert the user through a visual que on the user's phone or on a display on the respirator. This que can also be in the form of a vibration on the respirator. The sensor can also be a pressure sensor that detects the ambient air pressure within the respirator and utilize a similar alert system as the one described for the pressure contact sensors.

FIG. 18 depicts an embodiment with a chin rest 38 that adds comfort while at the same time enhancing the capability of the respirator to fit various facial geometries. The chin rest can comprise the same material as the pliable material of the respirator and resides on the inside of the respirator surface. It can also enhance the sealing capability of the pliable perimeter.

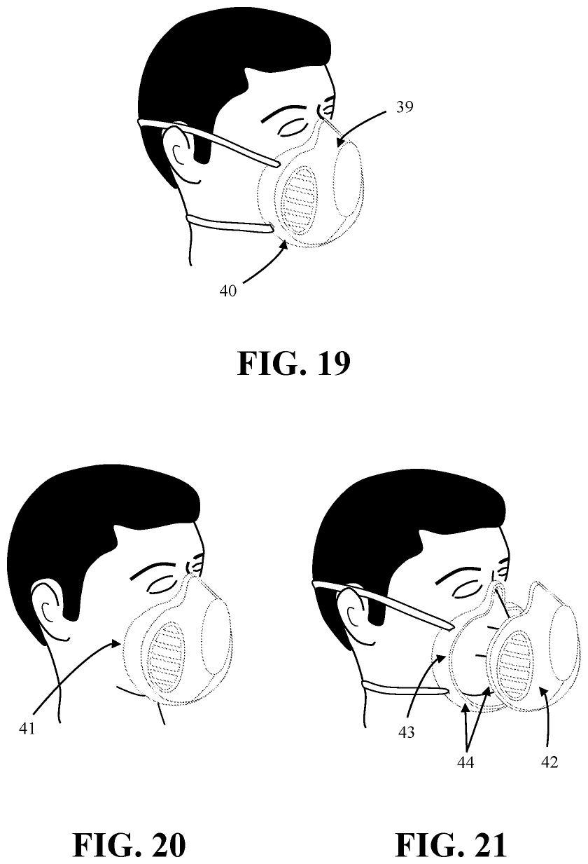

The respirator, as depicted in the embodiment in FIG. 19, comprises two principal regions: a distal cup region 39 and a proximal cup region 40. The distal cup region resides distally with respect to the user's face when the respirator is worn, while the proximal cup region resides proximally with respect to the user's face when the respirator is worn. The proximal cup can exist as an interface component that stretches and conforms to the user's face, while the distal cup can exist as a rigid, or semi rigid, structure. The rigidity of the distal cup can help with the overall durability of the respirator, as well as provide a solid structure where the securing member or other articles can be attached.

Granular jamming technology uses granular materials, such as small polymer spheres, enclosed within a sack-like structure whose walls are impermeable to air, such as a vacuum bag. When air is removed from this enclosed structure using an air pump, the rigidity of the structure increases due to the reduction in volume of the structure and the spheres compressing against each other and the inside walls of the structure. When this happens, the structure retains any contours of any objects that the structure was in contact with prior to the air being removed.

Granular jamming technology is employed in the proximal cup of the embodiment depicted in FIG. 20. In this embodiment, the perimeter of the proximal end of the cup 41 is comprised of a sack-like structure with walls that are impermeable to air. Small spheres are enclosed within this structure. The user simply places the respirator against his or her face and applies pressure so that the proximal end of the respirator, containing the granular material, contours to the user's face. Once this has been done, a small air pump is activated and removes air from the structure through a connecting tube. The respirator is now contoured to the user's face and attached without the need for a harnessing system. To remove the respirator, the user simply adds air to the structure to increase its volume and reduces the compressive force on the granular material. This can be done by reversing the flow of air with the air pump or by opening a valve to allow ambient air to enter the structure. By employing granular technology in the respirator, the user has the freedom to remove and attach the respirator without the hassle and discomfort of having to use a harnessing system.

A similar technology called layer jamming employs layers of materials such as fabrics, Kapton, or Polyester. Just like with granular jamming, layer jamming employs a sack like structure in which air is removed. This creates a rigid state through compressive forces and at the same time through the resistive forces which act against the sliding motion of the layers. This construct, just as with granular jamming, retains the contours of the shape of any object it is in contact with prior to the air being removed. In another embodiment, similar to the one depicted in FIG. 20, layer jamming technology is employed.

FIG. 21 depicts another embodiment where granular jamming technology is employed to join the distal region to the proximal region of the respirator. In this embodiment the distal region 42 can be attached to and removed from the proximal region 43 through the use of granular jamming technology. The granular jamming interface exists on the distal side of the proximal cup and on the proximal end of the distal cup 44. In other embodiments, the system employs granular jamming technology on multiple ends to adhere the respirator to the face, to join the distal cup to the proximal cup, to adhere the securing member for the filter, or for another purpose. Layer jamming technology is employed in other embodiments in place of granular jamming technology or in combination with it.

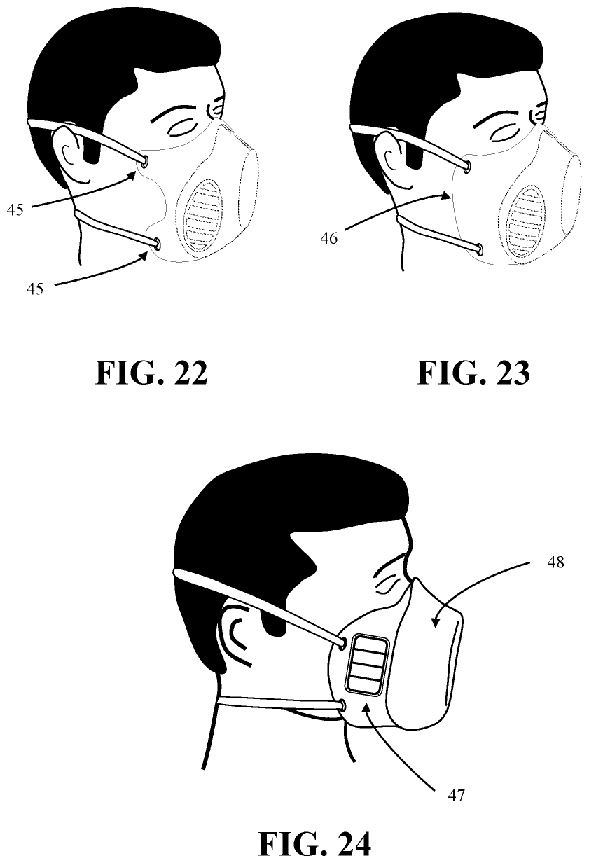

FIG. 22 highlights areas on the respirator where harnessing straps can be attached. The harnessing points of attachment extend further than other regions of the respirator and by doing so provide a strain relief, or dampening effect, from the forces imparted by the harness to the respirator 45 while at the same time providing additional sealing coverage. FIG. 23 depicts an embodiment where additional material exists around the area of the mouth and between the dampening features to provide more sealing coverage and strain relief 46. Additional material added to the sides of the respirator also provides an area where a filter chamber can be placed 47, as depicted in the embodiment of FIG. 24. By placing the chamber in this area, the surface area distal to the user's face 48 becomes available for other features, such as an area of the respirator that is transparent. A transparent area provides the opportunity for improved interaction and communication between the user and others because facial expressions and the mouth are visible. To enhance the visibility, components that can defog the visible portion of the respirator are used in one embodiment. The defogging component can comprise heating elements that line the surface of the transparent area or line areas near it. It can be activated by the user, or by a timer, or activated by a sensor that detects when the transparent areas have become foggy or when the humidity of the interior space has reached a certain level. This distal area can also be used to attach or embed wearable technology components such as sensors or other electronic components.

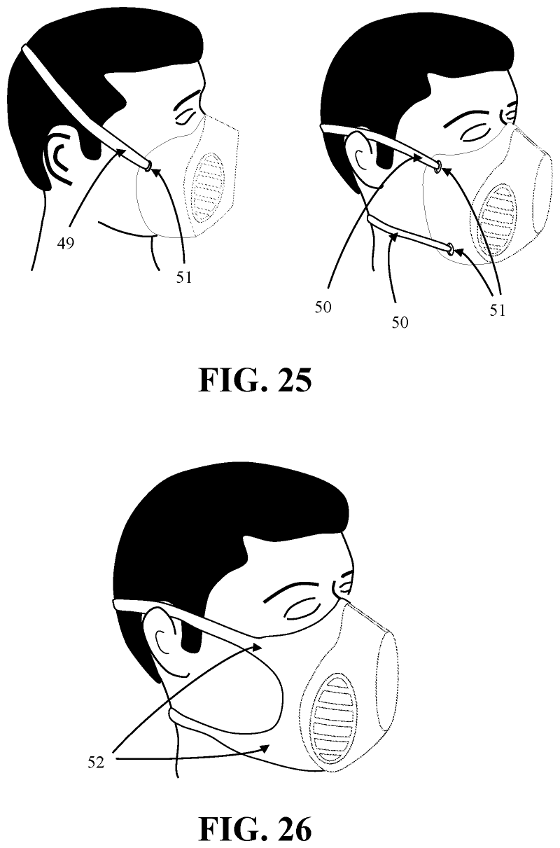

The respirator can be held in place with a single strap 49 or two straps 50 as shown in FIG. 25. Other embodiments exist where more than two straps can be used. The straps can comprise an elastic and adjustable material that can be inserted into loops 51 in the compliant material of the respirator. In another embodiment, the straps comprise the same compliant material that the respirator is comprised of, or it can comprise other materials previously mentioned. The straps in this embodiment can, in the same way as the previously mentioned straps, be inserted into the loops of the respirator for attachment. In another embodiment, as shown in FIG. 26, the straps comprise the same compliant material 52 as the respirator and are continuous with the respirator. In other words, the respirator and the straps are one piece.

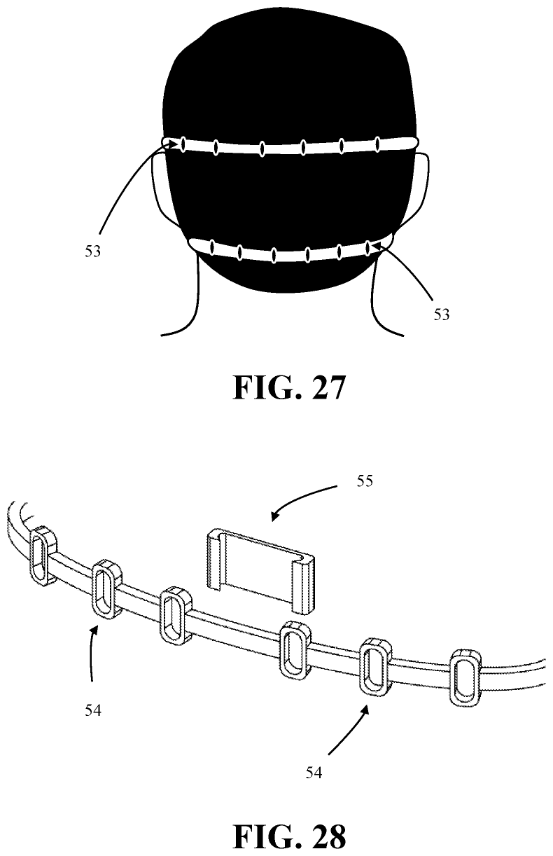

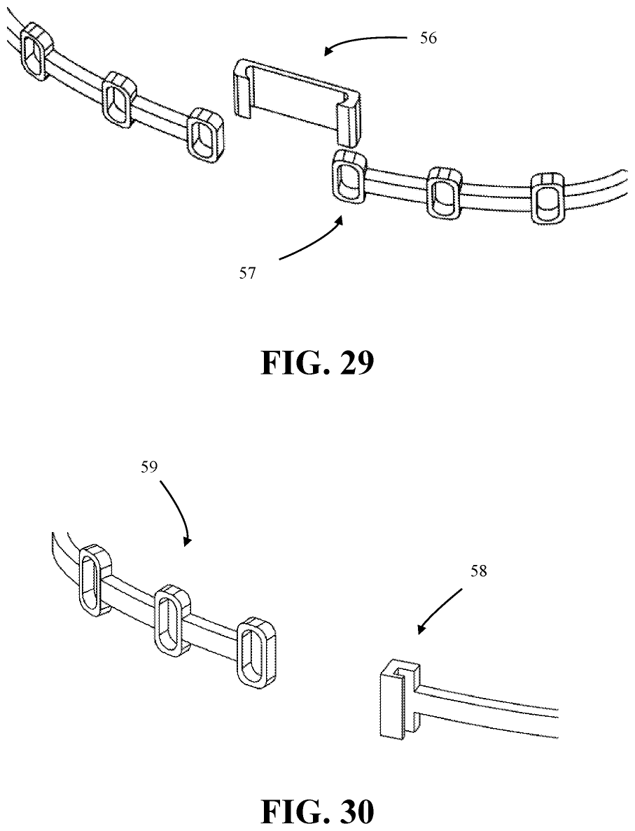

In the embodiment depicted in FIG. 27, the harness extends around the back of the user's head as one continuous piece and has several loops 53. These loops 54, as shown in FIG. 28, allow for the length of this flexible and stretchable region to be decreased by using a clasping element 55 to join them, thus increasing the tension on the straps and increasing the pressure of the respirator against the user's face. If a known length has been determined after fitting the respirator, the user has the option to cut any excess strap and loop material that is unneeded, as depicted in FIG. 29, and use the clasp 56 to hook onto any of the remaining loops 57 so that a comfortable yet adequate amount of tension is provided. In another embodiment of the harness system, the harness is configured with the straps as a continuous piece of the respirator, but independent from each other. They would look and work in a way similar to that described in FIG. 29. FIG. 30 depicts the embodiment of a strap that is not a continuous piece, and in which the clasp exists on one end of one of the straps 58. In this configuration the single ended clasp can hook on to any of the loops from the other strap 59.

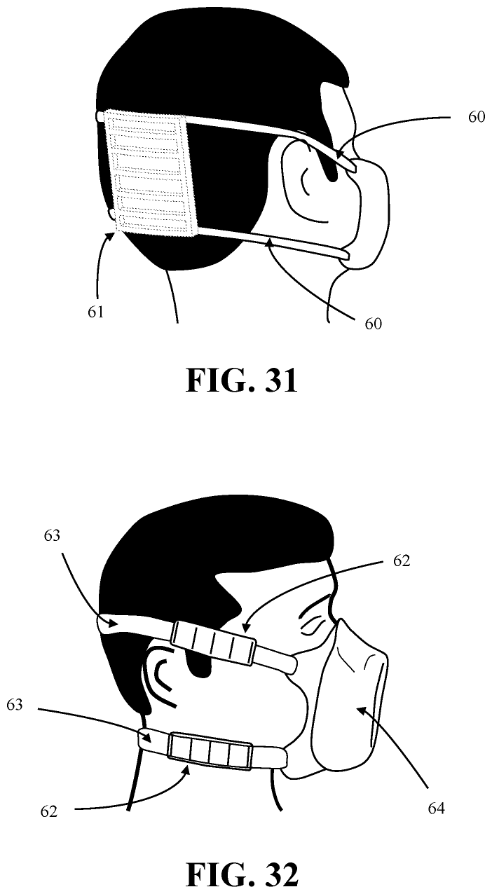

The filtering systems of respirators previously described here reside with the main body of the respirator structure, sometimes referred to as the distal region. In different embodiments the filter structure exists in-line with the harnessing structure. FIG. 31 depicts a structure that serves as both a harness and a lumen in which air can flow 60. The harness/lumen joins the filtering structure 61, which is situated on the posterior side of the head, to the main chamber of the respirator where the user inhales and exhales. In another embodiment, as depicted in FIG. 32, the filtering structure 62 is part of the harness structure 63 and is located on the side of the head. Air flows to and from the distal region of the respirator 64 compartment through the lumens in the harness and the filter system located within the harness.

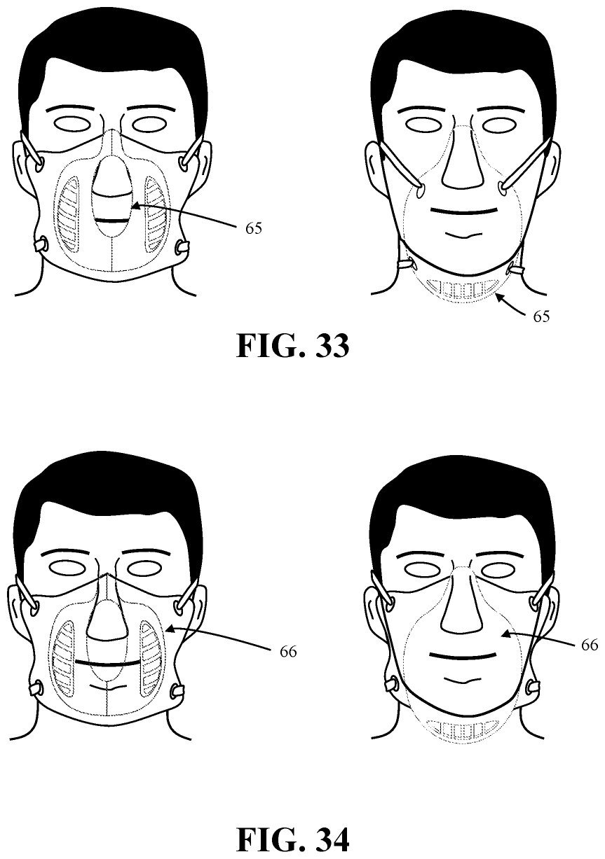

An often-cited deficiency in mask and respirator designs is that a majority of the user's face cannot be seen when the user is wearing it. This shortcoming is especially obvious during verbal communication and non-verbal communication. For example, facial expressions that are important means for communication with others cannot be fully appreciated while wearing a mask. Embodiments of the invention address this by using clear or semi-clear materials to permit visibility of the user's face. FIG. 33 depicts an embodiment where a distal region of the respirator is comprised of an area that is clear 65. The clear area can be comprised of a compliant material such as silicone, or a more rigid material such as polyethylene terephthalate glycol-modified or polyethylene terephthalate. In a similar embodiment, FIG. 34, the distal and proximal regions of the respirator 66 are partially or entirely comprised of a clear material allowing for visibility of additional areas of the user's face. The distal region for this embodiment can also be comprised of a clear and compliant material such as silicone, or a more rigid material such as polyethylene terephthalate glycol-modified or polyethylene terephthalate. In both embodiments, the proximal section can be comprised of the same or similar materials. A filter disposed under the user's mouth or chin, as shown on the right of the figure, can further facilitate communication with facial expressions or lip reading by leaving the mouth visible through the clear material.

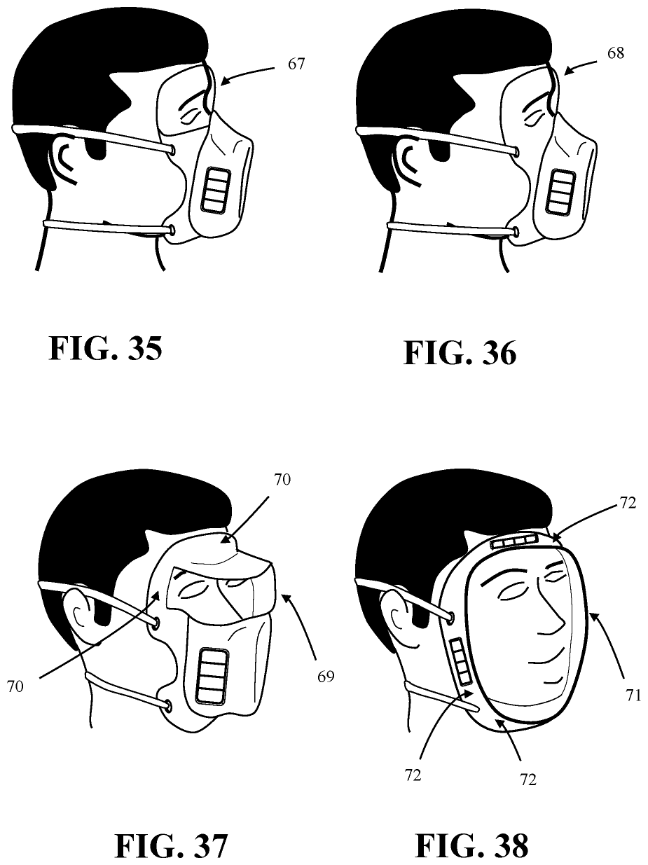

Various embodiments of the respirator exist that, in addition to providing protection to the nose and mouth, also provide protection to the eyes. FIG. 35 depicts an embodiment in which a protective shield 67 can be attached to the respirator to protect exposure to the eyes. The shield is attached by sliding into place along grooves, or in another embodiment, by means of a clipping mechanism. This configuration incorporates the protective barrier that a plastic face field provides, but with the added benefit of also providing respiratory protection. FIG. 36 depicts an embodiment in which the proximal region of the respirator consists of a clear material 68 that extends to cover the eyes. FIG. 37 is an embodiment where the protective eye region extends away from the user's eyes 69 and is surrounded by stretchable and pliable materials 70 so that the sealing capability of the proximal region of the respirator is extended to the eye region. FIG. 38 depicts an embodiment where a clear region of material is used to protect the eyes, nose, and mouth 71. The clear region is encapsulated around its perimeter with soft and pliable material 72 and is also used to provide a seal around the user's face.

Additional embodiments exist that add to the aesthetic appeal of the respirator. For example, the respirator can be manufactured so that the end product comprises one or more colors. Logos, words, or other materials can be embedded within the respirator or imprinted on its surface for decorative purposes or to communicate an idea or message.

Other embodiments exist to further enhance its utility. In these embodiments the respirator can be embedded with sensors and a microprocessor, or other wearable technology components. For example, sensors can be used to detect the pressure differential of the respirator. Changes in the pressure differential can indicate changes in the sealing efficiency or changes in the filtering capacity. Other embodiments comprise elements embedded on it or within it that are used for sterilization purposes such as heating elements and or UV technology. Electroactive polymers or actuators are employed to assist in changing the geometry in one embodiment for various purposes, such as changing its geometry to improve its fit and or comfort. In another embodiment, the respirator is configured so that a special adhesive, such as a tape, can be used with it to further improve its sealing capability and or its ability to adhere to the user's face.

In one embodiment where communication is improved, a microphone and speaker system is employed to assist with communication. The microphone resides on the inside of the respirator to capture the speech from the user, and a speaker resides on the outside of the respirator to output the user's speech. Similarly, in another embodiment, a screen displays the user's speech detected with a microphone and processed with a microprocessor.

As part of a visual appeal and communication enhancement, a camera or multiple cameras can be mounted on the inside of the respirator. These cameras can be used to capture images of the user's face so that they can then be projected onto the outside surface of the respirator, or the inside surface if the material allows transmission of an image from the inner surface to the outer surface. In this embodiment the outside projection reduces the appearance of a respirator being used by displaying the user's face.

In another embodiment, the respirator has areas where lights are mounted to it to assist the user with vision, or again, to add to the aesthetic appeal.

In another embodiment, the contouring material of the respirator is configured with hollow chambers between the outside surface and the inside surface of the respirator. These hollow chambers allow for matter to flow which are used for temperature control to provide the user with a more comfortable experience.

Some embodiments of the device are configured to allow for the attachment of oxygen canisters.

Embodiments of the invention exist with the capability of drug delivery. The mode of delivery can be transdermal or through an inhalant. The administration of the drug can be controlled through microprocessor technology or through a time-release mechanism.

In embodiments where eye protection is employed, the material used to shield the eyes can comprise a display where information can be communicated for the user to see. This information can relate to data that the respirator is collecting, it can be information sent from the user's phone or another device, or it could be information originating from an outside source.

Other embodiments of the respirator employ wireless communication systems so that the respirator can be in communication with other technology, such as a cell phone.

### MODES FOR CARRYING OUT THE INVENTION

The respirator can be constructed out of a material that is pliable so as to conform to the user's face so that there is an adequate seal between the respirator and the user's face. The material can also maintain a certain rigidity in its structure around the anterior aspect of the configuration so as to allow space for the user's mouth and nose. A material that can be poured into a mold, or thermoformed, into the required shape and with the previously described features, such as a polymer is preferred but not limited to such a material.

The construction of the filter chamber and any associated members used to cover the filter chamber and or hold the filter in place can be created through the forming of the respirator using the mold or the thermoforming process, or it can be created independently of the respirator using a more rigid material such as a urethane or epoxy using a molding or thermoforming process and then positioned within the molding or thermoforming jig when the respirator is created. The chamber is included in the manufacturing of the respirator to encapsulate it within the pliable material to reduce or eliminate pathways through which particles can travel between the pliable material of the respirator and the chamber. A glue or other sealant can be used to ensure complete closure of any pathways if necessary.

Wearable technology can be added to the manufacturing process of the respirator structure by embedding the technology during the molding process. Or it can be added post processing by mounting it to the article. Wearable technology can consist of, but is not limited to, sensors, microprocessors, pumps, soft robotic materials, actuators, tubes, cables, wires, power sources, and other electronic components.

The straps used to hold the respirator against the user's face can be purchased as an off the shelf material and it can be an elastic material as seen in the textile industry. It can be cut to the appropriate size and attached to the respirator through loops that can be formed during the molding or thermoforming process of the pliable material. If the straps are to be comprised of the same pliable material as the respirator, the jig for the mold or thermoforming process should be configured to accommodate the inclusion of a strap configuration as part of the pliable material.

This is one mode for carrying out the production of one of the embodiments of the device. Other modes and other embodiments of the device exist.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

We claim:

1. A respirator comprising
(a) a cup portion shaped to substantially conform to a user's face and comprising a material that is impermeable to air, and having one or more openings therethrough that permit passage of air from outside cup to inside the cup;
(b) one or more filter elements, comprising a material that is permeable to air and impermeable to contaminants in air, and configured to removably and sealingly engage the cup portion at each opening such that air passing though the opening must pass through the filter material.

2. The respirator of claim 1, wherein the filter element is configured to snap or slide into a corresponding feature on the cup portion near the corresponding opening.

3. The respirator of claim 2, wherein the filter element is configured to snap or slide into the cup portion from a side of the cup portion facing away from the user.

4. The respirator of claim 2, wherein the filter element is configured to snap or slide into the cup portion from a side of the cup portion facing toward the user.

5. The respirator of claim 1, wherein the filter element comprises a filter material portion and a carrier portion, wherein the carrier portion secures the filter material portion when the carrier portion is engaged with the cup portion.

6. The respirator of claim 1, wherein the filter element comprises a filter material portion and a carrier portion having two parts, wherein the carrier portion secures the filter material portion between the two parts of the carrier portion.

7. The respirator of claim 1, further comprising one or more securing elements, wherein a securing element holds the filter element in position relative to the cup portion.

8. The respirator of claim 1, wherein the cup portion comprises a sealing portion comprising a pliable material, disposed on a portion of the cup portion that is proximal the user's face.

9. The respirator of claim 1, wherein the cup portion further comprises one or more superstructures mounted with and extending away from the cup portion, and configured to block air-borne particulates from impacting the filter element directly.

10. The respirator of claim 1, further comprising one or more sensors mounted with the cup portion and configured to detect a status of the respirator that indicates maintenance or replacement of the respirator or parts of the respirator, or an unsafe condition of a user of the respirator.

11. The respirator of claim 1, further comprising one or more disinfecting units mounted with the respirator and configured to reduce the harmful effects of contaminants in air impinging on or passing through the filter element.

12. The respirator of claim 1, further comprising one or more filter element blocking elements, each configured to block airflow through a corresponding filter element and configured to removably mount with the respirator such that the filter element blocking elements can be mounted and removed from the respirator separate from the filter elements.

13. A respirator comprising
(a) a cup portion configured to mount with a user's face and substantially impermeable to air;
(b) one or more strap elements configured to mount with the cup portion and to secure the cup portion to the user's face, wherein the strap elements define an internal lumen that is permeable to air and that has an opening into a region between the cup portion and the user's face;
(c) one or more filter assemblies, mounted with the strap elements and communicating ambient air through a filter material to the lumen of the strap element.

14. The respirator of claim 13, wherein the filter element is configured to snap or slide into the filter assembly.

15. The respirator of claim 13, wherein the filter element comprises a filter material portion and a carrier portion, wherein the carrier portion secures the filter material portion when the carrier portion is engaged with the filter assembly.

16. The respirator of claim 13, wherein the filter element comprises a filter material portion and a carrier portion having two parts, wherein the carrier portion secures the filter material portion between the two parts of the carrier portion.

17. The respirator of claim 13, further comprising one or more securing elements, wherein a securing element holds the filter element in position relative to the filter assembly.

18. The respirator of claim 1, further comprising one or more sensors mounted with the cup portion and configured to detect a condition of the seal between the respirator and the user.

19. The respirator of claim 1, further comprising a timer mounted with the respirator that indicates usage of the respirator.

20. The respirator of claim 8, wherein the sealing portion comprises a granular jamming or layer jamming structure.

21. The respirator of claim 8, wherein the sealing portion comprises a pneumatic structure.

22. The respirator of claim 1, wherein a region of the cup portion is optically transparent, and further comprising a sensor indicative of conditions that indicate the optically transparent region is fogged, and a defogging system responsive to the sensor.

23. The respirator of claim 1, wherein the filter elements are electrostatically charged.
